(19) United States
(12) Patent Application Publication
(10) Pub. No.: US 2023/0329225 A1
(43) Pub. Date: Oct. 19, 2023

(54) Systems and Methods of Controlling Iguana Infestation

(71) Applicant: Thomas Portuallo, Coral Springs, FL (US)

(72) Inventor: Thomas Portuallo, Coral Springs, FL (US)

(73) Assignee: Blue Iguana Pest Control, Inc., Coral Springs, FL (US)

(21) Appl. No.: 18/336,996

(22) Filed: Jun. 17, 2023

Related U.S. Application Data
(63) Continuation-in-part of application No. 17/446,888, filed on Sep. 3, 2021, now Pat. No. 11,690,372.
Application No. 17/446,888 is a continuation of application No. 15/263,142, filed on Sep. 12, 2016, now Pat. No. 11,122,793.

(51) Int. Cl. A01M 29/30

(52) U.S. Cl. CPC A01M 29/30

(57) ABSTRACT

Systems and methods of controlling iguana infestation in an area of real property are disclosed. The systems and methods, being harmless to people and pets, can include the installation of a fence barrier, wall barrier, sea wall barrier, ground barrier, subsurface barrier, and/or climbing barrier to the area of real property. The systems and methods can include tree wraps, piling wraps, wall wraps, etc. The sea wall barrier can prevent iguanas from accessing property from the water. Piling wraps can be included to prohibit access to the property via the dock. Tree guards can be included to prevent iguanas from climbing up vertical structures such as trees and utility poles.

### CROSS-REFERENCE TO RELATED APPLICATIONS

This application is a continuation-in-part of U.S. patent application Ser. No. 17/446,888 filed on Sep. 3, 2021, which is a continuation of U.S. patent application Ser. No. 15/263,142 filed on Sep. 12, 2016 (now U.S. Pat. No. 11,122,793), the contents of which are relied upon and incorporated herein by reference in their entireties, and which the benefit of priority under 35 U.S.C. § 120 is hereby claimed.

### FIELD

The present disclosure generally relates to controlling pest infestation, and more particularly to controlling iguana infestation.

### BACKGROUND

Iguanas are herbivorous lizards that are native to tropical areas of Mexico, Central America, and the Caribbean. They range in size between five and six feet long. Most people are familiar with the common green iguana. These pests are non-native to North America and the infestation of iguanas in the United States have caused havoc for residents and native species.

South and Central Florida's subtropical climate allows these large herbivorous (plant-eating) lizards to survive, reproduce, and become part of the Florida environment. Three large members of the iguana family (Iguanidae) have become established in South Florida.

Adult iguanas feed on foliage, flowers, and fruit. They occasionally eat animal material such as insects, lizards, and other small animals, nestling birds and eggs. Juveniles eat more animal material, especially insects. Hatchling green iguanas eat the droppings of adult iguanas to acquire the gut bacteria that help them digest plant material. Males are territorial against other males but are not territorial against females and juveniles. These large lizards like to bask in open areas, sidewalks, docks, seawalls, landscape timbers, or open mowed areas. If frightened, they dive into water (green iguanas and basilisks) or retreat into their burrows (spiny tailed iguanas). This habit of diving into the water to escape makes green iguanas very difficult to capture. Basilisks and anoles generally eat insects and small vertebrate prey, but knight anoles occasionally eat small fruits and flowers as well.

Damage caused by iguanas includes eating valuable landscape plants, shrubs, and trees, eating orchids and many other flowers, eating dooryard fruit like berries, figs, mangos, tomatoes, bananas, lychees, etc. Iguanas do not eat citrus. They dig burrows that undermine sidewalks, seawalls, and foundations. Iguana burrows next to seawalls allow erosion and eventual collapse of those seawalls. Iguana droppings litter areas where they bask. This is unsightly, causes odor complaints, and is a possible source of salmonella bacteria, a common cause of food poisoning. Adult iguanas are large powerful animals that can bite, cause severe scratch wounds with their extremely sharp claws, and deliver a painful slap with their powerful tail. Iguanas normally avoid people but will defend themselves against pets and people that try to catch them or corner them.

Iguanas defecate in common public areas such as pools, parks, playgrounds, and docks, causing health risks as their feces carry salmonella. Moreover, the burrows they dig, which can be up to 9 feet in length, undermine sidewalks, seawalls, and foundations causing structural damage. The four-footed reptiles eat their way through landscaping. They sunbathe during the day and cozy up in treetops by night. They can lay as many as three dozen eggs in a single burrow. Although iguanas are docile, there are many reported incidents where they have harmed pets and individuals. As with any species, they are territorial, the more dominant males will push the less dominant males to surrounding areas, which leads to infestation.

If an iguana is removed from an area of real property, another will come to take its place. As such, systems and methods of preventing iguanas from nesting, residing, and/or traveling on the real property is needed. In other words, there is a need for controlling iguana infestation on real property.

### SUMMARY

In various embodiments, comprehensive systems and methods of creating an environment to control iguana infestation are provided. The systems and methods are harmless to people and pets. The systems and methods can include an iguana barrier that creates a temporary wall (used on initial treatment of infested property). The systems and methods can include an iguana sea wall barrier that prevents iguanas from accessing the property from the water. The systems and methods can include iguana piling wraps that prohibit access via the dock. The systems and methods can include iguana tree guards that prevent iguanas from climbing up into trees. In various embodiments, the iguana systems and methods have been proven to remove iguana from infested areas.

In various embodiments, a method of protecting an area of real property from an iguana is disclosed, the area of real property comprising a seawall that is adjacent to a body of water, the method comprising: installing a water barrier to the area of real property, the water barrier being configured to prevent the iguana from entering the area of real property from the adjacent body of water; the water barrier comprising: an end cap configured to prevent the iguana from climbing up or across the seawall from the body of water to the adjacent area of real property, the end cap having a portion that hangs over the seawall.

In some embodiments, the end cap comprises an end cap wrap covering the portion hanging over the seawall; the end cap wrap consisting of high-density polyethylene (HDPE) or polyethylene high-density (PEHD); and wherein the end cap wrap comprises a smooth surface and is installed with the smooth surface exposed, preventing the iguana from climbing past the end cap wrap.

In some embodiments, the water barrier further comprises a piling wrap secured around a piling in the body of water such that the piling wrap is positioned above the body of water. In some embodiments, the piling wrap consists of high-density polyethylene (HDPE) or polyethylene high-density (PEHD).

In some embodiments, the water barrier further comprises a seawall wrap secured to the seawall. In some embodiments, the seawall wrap consists of high-density polyethylene (HDPE) or polyethylene high-density (PEHD).

In some embodiments, the method comprises installing a land barrier to a fence positioned at a perimeter of the area of real property to be protected to prevent the iguana from walking into the area, the land barrier comprising a plurality of fence barriers and a plurality of fence wraps, wherein each fence barrier extends from a horizontal rail of the fence positioned near a ground surface to each respective fence wrap; wherein at least one of the plurality of fence wraps is attached to an external face of the fence, wherein each fence wrap on the external face of the fence includes a substantially flat first surface in contact with the external face of the fence; and wherein each fence wrap is positioned at a spaced distance from a ground surface, and each fence wrap includes a substantially flat second surface opposite the substantially flat first surface, the second surface consisting of the smooth surface. In some embodiments, each fence wrap consists of high-density polyethylene (HDPE) or polyethylene high-density (PEHD), and wherein each fence wrap comprises a smooth surface and is installed with the smooth surface exposed, preventing the iguana from climbing past the respective wrap.

In some embodiments, the method comprises installing a climbing barrier to prevent the iguana from climbing up a vertical structure and entering from above the area of real property to be protected, the climbing barrier comprising at least one tree wrap coupled to at least one vertical structure. In some embodiments, each respective tree wrap consists of high-density polyethylene (HDPE) or polyethylene high-density (PEHD), and each respective tree wrap is installed such that a smooth surface is exposed, preventing the iguana from climbing past the respective tree wrap.

In some embodiments, the method comprises installing a subsurface barrier around a hole or burrow at the perimeter of the area to be protected to prevent the iguana from entering the area, the subsurface barrier comprising a piece of mesh; wherein the installing the subsurface barrier comprises a step of widening an area around the hole or burrow, a step of collapsing the hole with dirt, a step of positioning the piece of mesh over the collapsed hole, and a step of covering the mesh with dirt.

In various embodiments, a method of protecting an area of real property from an iguana is disclosed, the method comprising: installing a climbing barrier to prevent the iguana from climbing up a vertical structure and entering the area to be protected from an elevated position on the vertical structure, wherein the climbing barrier comprises a wrap coupled to the vertical structure; wherein the wrap consists of high-density polyethylene (HDPE) or polyethylene high-density (PEHD); wherein the wrap comprises a smooth surface and the wrap is installed with the smooth surface exposed and not in contact with the vertical structure; and wherein the smooth surface prevents the iguana from climbing past the respective wrap.

In some embodiments, the method comprises filling any space between the wrap and the vertical structure with an expanding spray foam composition. In some embodiments, the vertical structure is a dock piling, tree, or a utility pole.

In some embodiments, the method comprises installing a subsurface barrier around a hole or burrow at the perimeter of the area to be protected to prevent the iguana from entering the area, the subsurface barrier comprising a piece of mesh; wherein the installing the subsurface barrier comprises a step of widening an area around the hole or burrow, a step of collapsing the hole with dirt, a step of positioning the piece of mesh over the collapsed hole, and a step of covering the mesh with dirt.

In various embodiments, a vertical barrier for preventing an iguana from climbing up a vertical structure is disclosed, the vertical barrier comprising a wrap consisting of high-density polyethylene (HDPE) or polyethylene high-density (PEHD), the wrap comprising a planar structure with a smooth surface on one face that prevents the iguana from climbing up and past the vertical barrier. In some embodiments, the vertical structure is configured for attaching to a dock piling, tree, or a utility pole.

In various embodiments, a method for protecting an area of real property from an iguana is disclosed, the method comprising: installing a land barrier to a fence positioned at a perimeter of the area of real property to be protected to prevent the iguana from walking into the area, the land barrier comprising a plurality of fence barriers and a plurality of fence wraps, wherein each fence barrier extends from a horizontal rail of the fence positioned near a ground surface to each respective fence wrap, wherein at least one of the plurality of fence wraps is attached to an external face of the fence, wherein each fence wrap on the external face of the fence includes a substantially flat first surface in contact with the external face of the fence; and wherein each fence wrap is positioned at a spaced distance from a ground surface, and each fence wrap includes a substantially flat second surface opposite the substantially flat first surface, the second surface being a smooth surface; and installing a climbing barrier to prevent the iguana from climbing up a tree and entering the area to be protected from above, wherein the climbing barrier comprises at least one tree wrap coupled to at least one tree; wherein each fence wrap and each tree wrap consists of one of high-density polyethylene (HDPE) or polyethylene high-density (PEHD), and each fence wrap and each tree wrap is installed such that a smooth surface is exposed, preventing the iguana from climbing past the respective wrap.

In some embodiments, each fence wrap is positioned at least one and a half feet above the ground surface. In some embodiments, the plurality of fence wraps further comprises at least one fence wrap positioned on an internal-facing surface of the fence, the internal-facing surface being the surface facing the area to be protected.

In some embodiments, the method comprises: installing a subsurface barrier around a hole or burrow at the perimeter of the area to be protected to prevent the iguana from entering the area, the subsurface barrier comprising a piece of mesh, wherein the installing the subsurface barrier comprises a step of widening an area around the hole or burrow, a step of collapsing the hole with dirt, and a step of positioning the piece of mesh over the collapsed hole; and wherein the installing the subsurface barrier optionally comprises a step of covering the mesh with dirt.

In some embodiments, the installing the climbing barrier further comprises filling a space between each tree wrap and a surface of the tree with spray foam.

In various embodiments, a method for protecting an area of real property from an iguana is disclosed, the method comprising: installing a land barrier to a fence positioned at a perimeter of the area of real property to be protected to prevent the iguana from walking into the area, the land barrier comprising a plurality of fence barriers and a plurality of fence wraps, wherein each fence barrier extends from a horizontal rail of the fence positioned near a ground surface to each respective fence wrap, wherein at least one of the plurality of fence wraps is attached to an external face of the fence, wherein each fence wrap on the external face of the fence includes a substantially flat first surface in contact with the external face of the fence; and wherein each fence wrap is positioned at a spaced distance from a ground surface, and each fence wrap includes a substantially flat second surface opposite the substantially flat first surface, the second surface being a smooth surface; installing at least one water barrier to prevent the iguana from crawling into the area to be protected from a body of water adjacent to the perimeter of the area, the at least one water barrier comprising a piling wrap secured around a piling in the body of water such that the piling wrap is above the body of water; and installing a climbing barrier to prevent the iguana from climbing up a tree and entering the area to be protected from above, wherein the climbing barrier comprises at least one tree wrap coupled to at least one tree; wherein each fence wrap, each piling wrap, and each tree wrap consists of one of high-density polyethylene (HDPE) or polyethylene high-density (PEHD), and each fence wrap, each piling wrap, and each tree wrap is installed such that a smooth surface is exposed, preventing the iguana from climbing past the respective wrap.

In some embodiments, each fence wrap is positioned at least one and a half feet above the ground surface. In some embodiments, the plurality of fence wraps further comprises at least one fence wrap positioned on an internal-facing surface of the fence, the internal-facing surface being the surface facing the area to be protected.

In some embodiments, the method further comprises installing a subsurface barrier around a hole or burrow at the perimeter of the area to be protected to prevent the iguana from entering the area, the subsurface barrier comprising a piece of mesh; wherein the installing the subsurface barrier comprises a step of widening an area around the hole or burrow, a step of collapsing the hole with dirt, a step of positioning the piece of mesh over the collapsed hole, and a step of covering the mesh with dirt.

In some embodiments, the at least one water barrier further includes an end cap configured to prevent the iguana from climbing up or across the seawall from the body of water to the adjacent area of real property, the end cap having a portion that hangs over the seawall. In some embodiments, the end cap comprises one of high-density polyethylene (HDPE) or polyethylene high-density (PEHD) forming a smooth surface that projects at an acute angle relative to the vertical surface of the seawall.

In various embodiments, a method for protecting an area of real property from an iguana is disclosed, the method comprising: installing a land barrier to a fence positioned at a perimeter of the area of real property to be protected to prevent the iguana from walking into the area, the land barrier comprising a plurality of fence barriers and a plurality of fence wraps, wherein each fence barrier extends from a horizontal rail of the fence positioned near a ground surface to each respective fence wrap, and wherein at least one of the plurality of fence wraps is attached to an external face of the fence, each fence wrap on the external face of the fence includes a substantially flat first surface in contact with the external face of the fence; installing a subsurface barrier around a hole or burrow at the perimeter of the area to be protected to prevent the iguana from entering the area, the subsurface barrier comprising a piece of mesh, wherein the installing the subsurface barrier comprises a step of widening an area around the hole or burrow, a step of collapsing the hole with dirt, and a step of positioning the piece of mesh over the collapsed hole; installing at least one water barrier to prevent the iguana from crawling into the area to be protected from a body of water adjacent to the perimeter of the area, the at least one water barrier comprising a piling wrap secured around a piling such that the piling wrap is above the body of water; and installing a climbing barrier to prevent the iguana from climbing up a tree and entering the area to be protected from above, wherein the climbing barrier comprises at least one tree wrap coupled to at least one tree; wherein each fence wrap, each piling wrap, and each tree wrap consists of one of high-density polyethylene (HDPE) or polyethylene high-density (PEHD), and each fence wrap, each piling wrap, and each tree wrap is installed such that a smooth surface is exposed, preventing the iguana from climbing past the respective wrap.

In some embodiments, the fence wrap is positioned at a spaced distance from the ground surface, and each fence wrap includes a substantially flat second surface opposite the substantially flat first surface, the second surface consisting of the smooth surface. In some embodiments, each fence wrap is sized with a height of at least three inches. In some embodiments, the fence comprises a plurality of evenly spaced vertical boards attached to the horizontal rail near the ground surface. In some embodiments, each fence wrap is positioned at least one and a half feet above the ground surface.

In some embodiments, the plurality of fence wraps further comprises at least one fence wrap positioned on an internal-facing surface of the fence, the internal-facing surface being the surface facing the area to be protected.

In some embodiments, the installing the subsurface barrier further comprises a step of covering the mesh with dirt. In some embodiments, each mesh fence barrier or each mesh in the subsurface barrier comprises a galvanized metal.

In some embodiments, the water barrier further includes an end cap attached to a vertical surface of an overhanging seawall, the end cap configured to prevent the iguana from climbing up or across the seawall. In some embodiments, the end cap comprises one of high-density polyethylene (HDPE) or polyethylene high-density (PEHD) forming a smooth surface that projects at an acute angle relative to the vertical surface of the seawall.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein and, together with the description, explain the principles and operations of the claimed subject matter.

### BRIEF DESCRIPTION OF THE DRAWINGS

A complete understanding of the present embodiments and the advantages and features thereof will be more readily understood by reference to the following detailed description, appended claims, and accompanying drawings, wherein:

FIG. 1 illustrates a method for controlling iguana infestation in accordance with an embodiment;

FIG. 2 illustrates an element, a tree wrap, of a system for controlling iguana infestation in accordance with an embodiment;

FIG. 3 illustrates another element, a piling wrap and seawall wrap, of a system for controlling iguana infestation in accordance with an embodiment;

FIG. 4 illustrates another element, a fence barrier, of a system for controlling iguana infestation in accordance with an embodiment;

FIG. 5 illustrates another element, a wire-mesh barrier, of a system for controlling iguana infestation in accordance with an embodiment; and

FIG. 6 illustrates another element, a sea wall barrier system, of a system for controlling iguana infestation in accordance with an embodiment.

The drawings are not necessarily to scale, and certain features and certain views of the drawings may be shown exaggerated in scale or in schematic in the interest of clarity and conciseness.

### DETAILED DESCRIPTION

Reference will now be made in detail to the exemplary embodiment(s), which are illustrated in the examples. Before describing the exemplary embodiments, it is noted the embodiments reside primarily in combinations of components, subcomponents, and procedures related to systems and methods of controlling iguana infestation. Accordingly, the system and method components have been represented where appropriate, showing only those specific details that are pertinent to understanding the embodiments of the present disclosure so as not to obscure the disclosure with details that will be readily apparent to those of ordinary skill in the art having the benefit of the description herein.

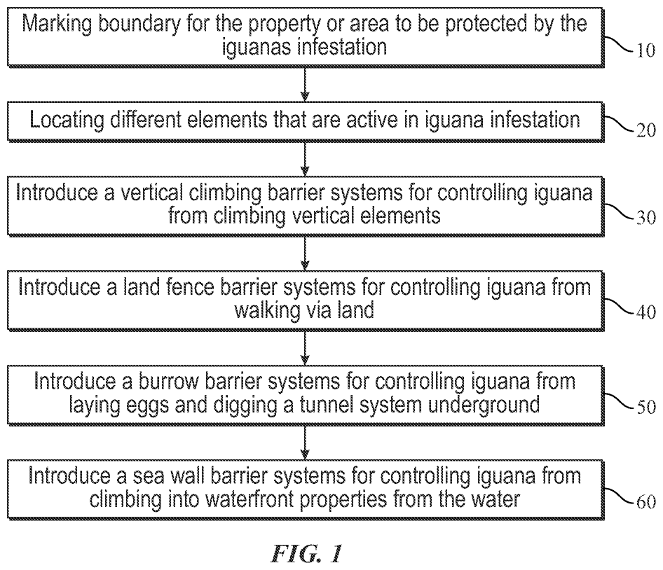

FIG. 1 illustrates a method for controlling iguana infestation in accordance with various embodiments. As iguanas are creatures of habit, when simply removed the iguana from a property, another will come to take its place. Instead, an effective solution is to create an environment where an iguana decides not to nest on the property. The method provided creates a holistic environment to prevent iguana infestation, while being harmless to occupants of the property including humans and pets.

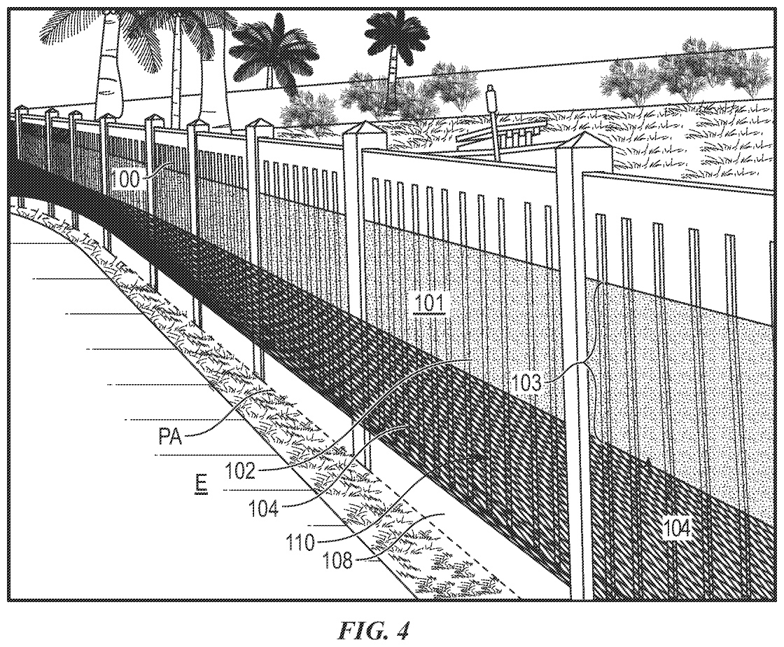

In some embodiments, the method shown in FIG. 1 comprises the step 10, which comprises marking the boundary PA for the property or area that is to be protected from the iguana infestation. The boundary PA for the protected property is real property as indicated with the broken line in FIG. 4. In some embodiments, the process includes step 20, which comprises locating the different elements that are active in iguana infestation. The different elements that may contribute to the iguana infestation can include the land-based access or sea/water-based access to the land that is to be protected. In some instances, the iguanas climb a vertical structure close to the property or area and contaminate the property or area via fecal matter or gain access to such property or area by jumping inside the boundaries via elevated platforms.

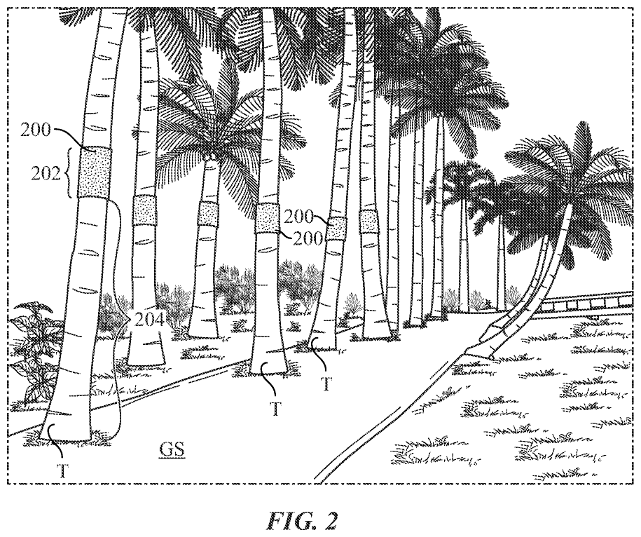

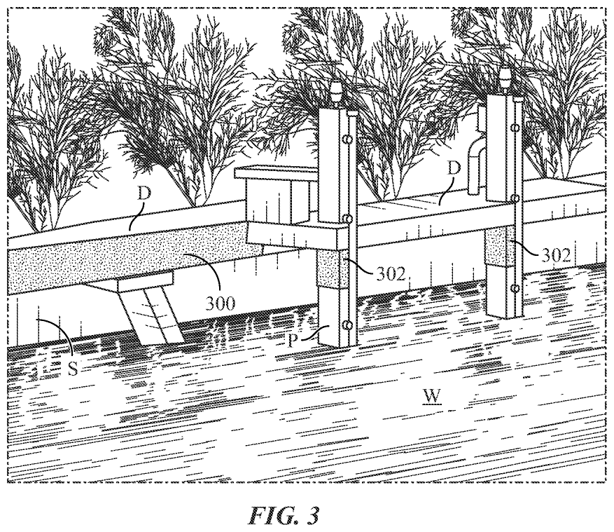

In some embodiments, the method comprises step 30. In such embodiments, the step 30 comprises installing one or more vertical climbing barrier systems configured to prevent an iguana from climbing a vertical element (structure). For example, FIG. 2 illustrates the tree wrap 200 as an element of a system for controlling iguana infestation in accordance with an embodiment. FIG. 3 illustrates another element, the piling wrap 302, of a system for controlling iguana infestation in accordance with an embodiment. In some embodiments, the step 30 includes attaching one or more wraps 200, 302 to the vertical structures. The wraps 200, 302 form a continuous wrap or sleeve around the climbing structure covering a span (e.g., 202) of the vertical structure. These vertical structures may include dock pilings (P), trees (T), utility poles, or the like, or any combination thereof.

In some embodiments, when the vertical climbing barrier system is attached to a tree or piling or the like, the vertical element includes an uneven surface that provides a space between the vertical barrier (e.g., wrap) and the surface of the vertical element. For example, a section of tree may have a greater diameter near the base of the tree relative to a position near the top of the base. Or, a tree many have an elbow, hole, or other surface blemish that results in a deepening in one or more areas of the surface. In some embodiments, the space may be large enough to allow iguanas to crawl between the vertical barrier and the surface of the vertical structure. Such space may leave a wrap ineffective in preventing the iguanas from gaining access to the top of such vertical structures. The method described herein can include a step to close the open spaces.

The space formed between the interior surface of the vertical climbing barrier and the surface of the vertical structure, due to the uneven surface of the vertical structure, may be protected by placing a barrier (e.g., mesh barrier) in the space and/or filing the space with foam. For example, the mesh barrier can be formed into a basket the size of the space and placed inside the space to prevent an iguana from crawling between the barrier and the wrap. For additional protection, the space is filled with spray foam that expands after application and thereby removes access to the space. Spray foam is a chemical product of materials that bubbles and/or expands up to 280 times its liquid volume after it is sprayed in place. This expansion makes it useful as a specialty packing material, which forms to the shape of the product being packaged and produces a high thermal insulating value with virtually no air infiltration.

In some embodiments, the vertical barrier wrap 200 and/or the piling wrap 302 are made of a high-density polyethylene (HDPE) or polyethylene high-density (PEHD). In some embodiments, the wrap is UV treated. In some embodiments, for example, the size 202 of the wrap for the vertical barrier may be thirty by thirty inches in size. A roll of the wrap may be up to 350 feet in length. The color of the wrap may be a close match to the color of the vertical structure. The steps involved in selecting the wrap may involve measuring the circumference of vertical structure at a point where the wrap is to be installed. For example, the point of interest for installing the wrap may be where the angle of the vertical structure is greater than forty-five (45) degrees or more, or above other foliage which would allow iguana to climb past the barrier. For aesthetic purpose the wrap may be installed at a same height 204 for all vertical structures, as shown in FIG. 2. If multiple wraps are used, they are overlap by at least 3 inches making a straight-line edges.

In some embodiments, one or more vertical barrier wraps may be used for a dock piling barrier. In some embodiments, a user can measure the circumference of the dock piling P just below support beams. Preferably, a high tide does not allow water to touch the piling wrap 302. If high tide causes water to reach the piling wrap, then the piling wrap can be raised to cover supports and trim accordingly. If multiple wraps are used, they can overlap, for example by three inches (3″), making a straight-line edges or trim excess. One example for fastening the piling wrap to the piling P may be to use a drill to create hole in wrap and piling and insert tabs.

In some embodiments, the method comprises step 40. In such embodiments, the step 40 comprises introducing a land fence barrier system configured to prevent an iguana from walking into the land to be protected. FIG. 4 illustrates a fence barrier 104, as an example of a system for controlling iguana infestation, between the horizontal rail 108 and the fence wrap 102. The fence barrier 104 can be made of any suitable material, including, for example, wire mesh, plastic (e.g., high-density polyethylene (HDPE) or polyethylene high-density (PEHD)), etc. The method may further include configuring an iguana specific fence wrap 102. The fence wrap 102 can be configured to prevent an iguana from climbing up and over the fence, thus restricting the iguana from crawling over land to gain access to the land being protected.

In some embodiments, the fence wrap 102 comprises one or more horizontally spanning fence wraps attached to at least the fence's outer face 101 at a certain height (spaced distance) above the ground. In some embodiments, the fence wrap 102 comprises a smooth side and the fence wrap 102 is attached to the fence with the smooth side being the external, unattached side (i.e., not facing the fence). In such embodiments, the smooth surface of the fence wrap 102 is exposed, preventing the iguana claws from gipping the wrap and thus preventing the iguana from climbing past the wrap on the fence. In some embodiments, the fence wrap 102 is placed on both the outside/exterior (E) side and on the inside/interior side of the fence 100. In some embodiments, the fence wrap 102 may be made of a high-density polyethylene (HDPE) or polyethylene high-density (PEHD). In some embodiments, the fence wrap 102 is UV treated.

In some embodiments, the fence wrap 102 forms a continuous band around the entire perimeter of the fence 100. In some embodiments, the fence wrap 102 has a height of at least half the average toe to toe length of an iguana. For example, the fence wrap 102 is at least three inches high. In some embodiments, the fence 100 is a picket fencing with the spacing 110 between vertical boards being at least two inch or less. Additionally, the height of the spaced distance at which the fence wrap is at least one and a half feet above the ground surface GS.

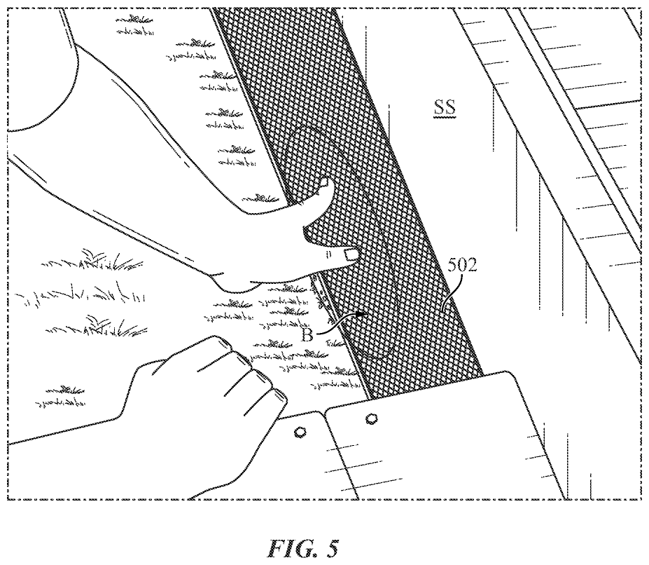

In some embodiments, the method comprises step 50. In such embodiments, the step 50 comprises installing a burrow barrier system configured to prevent an iguana from laying eggs and/or digging a tunnel system underground the surface structure SS. FIG. 5 illustrates another element, the wire-mesh barrier 502, of a system for controlling iguana infestation in accordance with an embodiment. In some embodiments, installing the subsurface barrier under the surface structure SS comprises creating an anti-hole barrier. Creating the anti-hole barrier includes locating the hole and/or burrow B, widening the area to a two feet by two feet area with the hole in the center of the widened area, collapsing the hole, and placing a two feet by two feet piece of mesh 502, covering the area with dirt. For example, the mesh is a half inch squares, galvanized metal nineteen gauge, welded, metal mesh.

For the anti-hole barrier, the method can include digging around the hole B with care to keep hole intact. For example, dig down approximately 1 foot and widen area to two feet by two feet area with the hole in the center. Cut mesh piece to fit the area (2′×2′). For example, the mesh maybe ½″ squares, 36″ tall, galvanized metal mesh with a nineteen-gauge, welded metal. Collapse hole and cover with mesh 502. Cover entire area with dirt and monitor following week for any activity.

In some embodiments, the burrow barrier may be a water wall barrier configured to prevent seawall access by an iguana by placing the seawall wrap 300 over a hole in the sea wall, as shown in FIG. 3. In such embodiments, the seawall wrap 300 prevents iguanas from digging holes further and also from climbing the walls. For example, the wrap can be cut to a size of eight inches by fifteen inches, including, for example, not less than twelve inches high. In some embodiments, the seawall wrap 300 may be made of a high-density polyethylene (HDPE) or polyethylene high-density (PEHD). In some embodiments, the fence wrap 102 is UV treated.

In one example, the wrap may be attached to the wall using a rivet. The user may use a hammer drill to make half inch (½″) deep hole with about quarter inch (¼″) diameter for inserting a rivet. Place wrap over hole and use punch to make hole in wrap. Next step may involve placing the wrap over the hole in sea wall and punching rivet to hold wrap in place. These rivets may be place both at the top edge and bottom edge of the wrap. Further example may involve placing the rivet every 8″ along top of wrap (which is placed within ½″ of top of sea wall on water side of seawall) and place rivet every 16″ on bottom within ½″ from bottom edge. Place all rivets so they are in equal spaces from each other and offers uniformed appearance. Continue placing the wrap until the end of the seawall is reached.

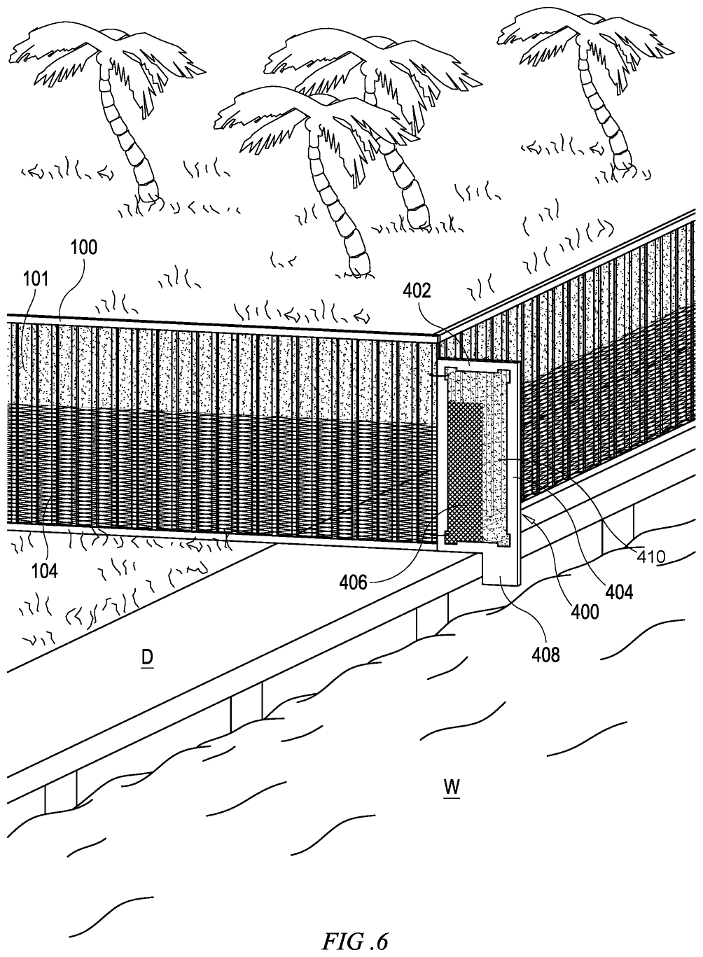

In some embodiments, the method comprises step 60. In such embodiments, the step 60 comprises installing a sea wall water barrier system for preventing an iguana from climbing into waterfront properties (e.g., deck D in FIG. 3) from the water W. In some embodiments, the water barrier system comprises an end cap 400 created for an overhanging seawall deck D, as shown in FIG. 6, which prevents iguanas from climbing up or across the sea wall. In some embodiments, the end cap 400 comprises a smooth acute angled cap on the edge of the seawall deck D, wherein the cap projects out at an acute angle to the sea wall's vertical surface.

As shown in FIG. 6, the end cap 400 may measure from six inch (6″) over (outwardly) the hanging sea wall deck D back to the fence 100 and/or wall barrier, etc. on the property being secured. The process of preparing a sea wall end cap 400 can include measuring down four inches (4″) from the edge of the overhanging sea wall deck D, and then measure back from this point to sea wall face. Cut one or more PVC sticks to fit and assemble “square” with the tab 408 overhanging the seawall. Assemble with angle and flat braces. Attach mesh 406 to one side of the end cap 400. Attach, e.g., with zip ties, 12″ strips of plastic end cap wrap 410 to cover the top edge 402, the side edge 404, and the overhanging tab 408. Anchor the end cap 400 to the fence 100 and/or into seawall deck D with screws and brackets. PVC should previously be painted the color of wrap being used. In some embodiments, the plastic end cap wrap 410 is made of a high-density polyethylene (HDPE) or polyethylene high-density (PEHD). In some embodiments, the plastic end cap wrap 410 may be UV treated.

The foregoing embodiments are provided to aid in the understanding of the present disclosure, the true scope of which is set forth in the appended claims. One of skill in the art would appreciate that modifications can be made in the embodiments set forth without departing from the spirit of the disclosure.

Exemplary embodiments and examples of the systems and methods are described above in detail. The systems and methods are not limited to the specific embodiments described herein, but rather, components of the systems and/or steps of the method may be utilized independently and separately from other components and/or steps described herein. For example, the system may also be used in combination with other systems and methods, and is not limited to practice with only a system as described herein. Rather, the exemplary embodiment can be implemented and utilized in connection with many other systems.

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context.

As used herein, the use of examples, or exemplary language (e.g., “such as”), is intended to illuminate the embodiments and does not pose a limitation on the scope of the claims unless otherwise stated. No language in the specification should be construed as indicating any non-claimed element as essential.

As used herein, the terms “about” and “substantially” will be understood by persons of ordinary skill in the art and will vary to some extent depending upon the context in which it is used. If there are uses of the term which are not clear to persons of ordinary skill in the art, given the context in which it is used, “about” and “substantially” will mean up to plus or minus 10% of the particular term.

This written description uses examples to disclose various embodiments, including the best mode, and to enable any person skilled in the art to practice the various embodiments, including carrying out the steps of the method. The patentable scope of the various embodiments is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

1. A method of protecting an area of real property from an iguana, the area of real property comprising a seawall that is adjacent to a body of water, the method comprising:
installing a water barrier to the area of real property, the water barrier being configured to prevent the iguana from entering the area of real property from the adjacent body of water; the water barrier comprising:
an end cap configured to prevent the iguana from climbing up or across the seawall from the body of water to the adjacent area of real property, the end cap having a portion that hangs over the seawall.

2. The method of claim 1, wherein the end cap comprises an end cap wrap covering the portion hanging over the seawall; the end cap wrap consisting of high-density polyethylene (HDPE) or polyethylene high-density (PEHD); and
wherein the end cap wrap comprises a smooth surface and is installed with the smooth surface exposed, preventing the iguana from climbing past the end cap wrap.

3. The method of claim 1, wherein the water barrier further comprises a piling wrap secured around a piling in the body of water such that the piling wrap is positioned above the body of water.

4. The method of claim 3, wherein the piling wrap consists of high-density polyethylene (HDPE) or polyethylene high-density (PEHD).

5. The method of claim 1, wherein the water barrier further comprises a seawall wrap secured to the seawall.

6. The method of claim 5, wherein the seawall wrap consists of high-density polyethylene (HDPE) or polyethylene high-density (PEHD).

7. The method of claim 1, further comprising installing a land barrier to a fence positioned at a perimeter of the area of real property to be protected to prevent the iguana from walking into the area, the land barrier comprising a plurality of fence barriers and a plurality of fence wraps,
wherein each fence barrier extends from a horizontal rail of the fence positioned near a ground surface to each respective fence wrap;
wherein at least one of the plurality of fence wraps is attached to an external face of the fence,
wherein each fence wrap on the external face of the fence includes a substantially flat first surface in contact with the external face of the fence; and
wherein each fence wrap is positioned at a spaced distance from a ground surface, and each fence wrap includes a substantially flat second surface opposite the substantially flat first surface, the second surface consisting of the smooth surface.

8. The method of claim 7, wherein each fence wrap consists of high-density polyethylene (HDPE) or polyethylene high-density (PEHD), and
wherein each fence wrap comprises a smooth surface and is installed with the smooth surface exposed, preventing the iguana from climbing past the respective wrap.

9. The method of claim 1, further comprising installing a climbing barrier to prevent the iguana from climbing up a vertical structure and entering from above the area of real property to be protected, the climbing barrier comprising at least one tree wrap coupled to at least one vertical structure.

10. The method of claim 9, wherein each respective tree wrap consists of high-density polyethylene (HDPE) or polyethylene high-density (PEHD), and each respective tree wrap is installed such that a smooth surface is exposed, preventing the iguana from climbing past the respective tree wrap.

11. The method of claim 1, further comprising installing a subsurface barrier around a hole or burrow at the perimeter of the area to be protected to prevent the iguana from entering the area, the subsurface barrier comprising a piece of mesh;
wherein the installing the subsurface barrier comprises a step of widening an area around the hole or burrow, a step of collapsing the hole with dirt, a step of positioning the piece of mesh over the collapsed hole, and a step of covering the mesh with dirt.

12. A method of protecting an area of real property from an iguana, the method comprising:
installing a climbing barrier to prevent the iguana from climbing up a vertical structure and entering the area to be protected from an elevated position on the vertical structure, wherein the climbing barrier comprises a wrap coupled to the vertical structure;
wherein the wrap consists of high-density polyethylene (HDPE) or polyethylene high-density (PEHD);
wherein the wrap comprises a smooth surface and the wrap is installed with the smooth surface exposed and not in contact with the vertical structure; and
wherein the smooth surface prevents the iguana from climbing past the respective wrap.

13. The method of claim 12, further comprising filling any space between the wrap and the vertical structure with an expanding spray foam composition.

14. The method of claim 12, wherein the vertical structure is a dock piling, tree, or a utility pole.

15. The method of claim 12, further comprising installing a subsurface barrier around a hole or burrow at the perimeter of the area to be protected to prevent the iguana from entering the area, the subsurface barrier comprising a piece of mesh;
wherein the installing the subsurface barrier comprises a step of widening an area around the hole or burrow, a step of collapsing the hole with dirt, a step of positioning the piece of mesh over the collapsed hole, and a step of covering the mesh with dirt.

16. A vertical barrier for preventing an iguana from climbing up a vertical structure, the vertical barrier comprising a wrap consisting of high-density polyethylene (HDPE) or polyethylene high-density (PEHD), the wrap comprising a planar structure with a smooth surface on one face that prevents the iguana from climbing up and past the vertical barrier.

17. The vertical barrier wrap of claim 16, wherein the vertical structure is configured for attaching to a dock piling, tree, or a utility pole.
